(19) United States
(12) Patent Application Publication
(10) Pub. No.: US 2010/0037431 A1
(43) Pub. Date: Feb. 18, 2010

(54) HINGE AND COLLAPSIBLE DEVICE UTILIZING THE SAME

(75) Inventor: CHEN-WEI CHIANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/241,026

(22) Filed: Sep. 29, 2008

(30) Foreign Application Priority Data
Aug. 12, 2008 (CN) 200820301807.9

(51) Int. Cl. E05D 11/08

(52) U.S. Cl. 16/342

(57) ABSTRACT

A hinge includes a first element and a second element. The first element includes a shaft sleeve. The shaft sleeve defines a receiving space along an axial direction, and a depressed part at its distal end. The second element includes an elastic shaft rotatably received in the receiving space, and a protruding portion protruding from the shaft being capable of sliding into the depressed part. A collapsible device utilizing the hinge is disclosed.

### CROSS-REFERENCE TO RELATED APPLICATION

This application is related to a co-pending U.S. patent application, Application No. [to be advised], Docket No. US22111, filed concurrently with the present application, entitled “HINGE AND COLLAPSIBLE DEVICE UTILIZING THE SAME”, which is assigned to the same assignee as that of the present application. The inventor of the co-pending application is Chen-Wei Chiang. The Specification and Drawings of the co-pending application is incorporated herein by reference.

### BACKGROUND

1. Technical Field

The invention relates to a hinge, and to a collapsible device utilizing the hinge.

2. Description of Related Art

A collapsible device, such as a notebook computer, or a clamshell mobile phone, generally includes a base, and a cover pivotably hinged on the base for covering or revealing a surface of the base. The hinge generally includes a female hinge member mounted to the cover and a male hinge member mounted to the base. The female hinge member includes a shaft sleeve, and the male hinge member includes a split shaft rotatably received in the shaft sleeve. The split shaft includes two friction portions in frictional engagement with an inner wall of the shaft sleeve during rotation of the shaft relative to the shaft sleeve. However, much force is required to rotate the split shaft because of friction between the split shaft and the inner wall of the shaft sleeve. Moreover, the force moment easily forces the cover to move quickly, and the cover easily bumps hard against the base when the cover is rotated closed.

### BRIEF DESCRIPTION OF THE DRAWINGS

FIG. 1 is an exploded, isometric view of an exemplary embodiment of a hinge.

FIG. 2 is similar to FIG. 1, but viewed from another perspective.

FIG. 3 is an assembled, isometric view of the hinge of FIG. 1.

FIG. 4 is an isometric view of a collapsible device utilizing the hinge of FIG. 3.

### DETAILED DESCRIPTION OF THE EMBODIMENTS

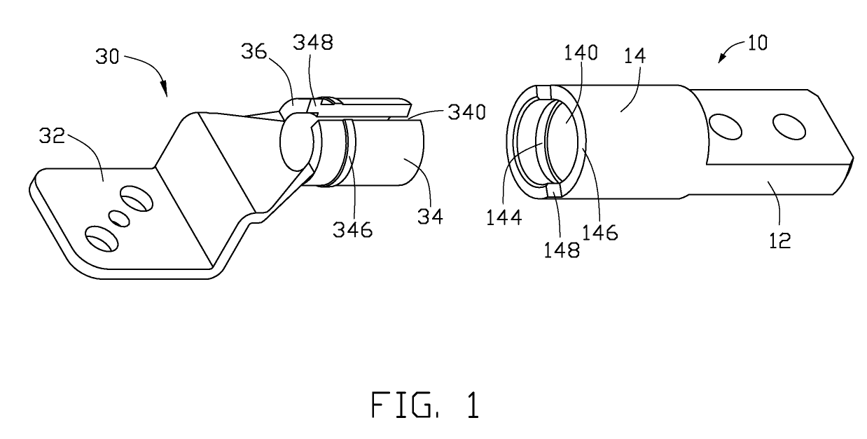

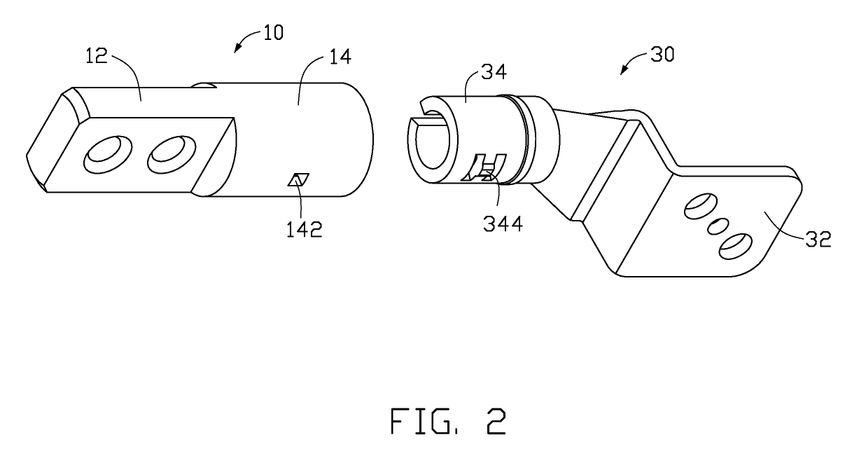

Referring to FIGS. 1 and 2, an exemplary hinge includes a first element 10 and a second element 30 capable of being pivotably mounted to the first element 10.

The first element 10 includes a flat connecting portion 12, and a shaft sleeve 14 extending from one end of the connecting portion 12.

A part of a distal end of the shaft sleeve 14 defines a depressed part 146. A stop surface 148 facing the depressed part 146 is formed at an end of the depressed part 146. The shaft sleeve 14 defines a receiving space 140. An inner wall of the shaft sleeve 14 defines a circular groove 144 adjacent to the depressed part 146. The shaft sleeve 14 defines a locating hole 142 communicating with the receiving space 140.

The second element 30 includes a flat locating portion 32, and an elastic tube-shaped shaft 34 extending from a first end of the locating portion 32.

The shaft 34 defines a slot 340 in a circumference of the shaft 34 along an axial direction and extending from the first end through the second end of the shaft 34. The slot 340 is configured for deforming the shaft 34. A part of the shaft 34 protrudes out to form an elastic locating protrusion 344 in its circumference, opposite to the slot 340. A circular projecting part 346 protrudes out from the circumference of the shaft 34, adjacent to the first end. An arc-shaped protruding portion 36 radially protrudes from the circumference of the shaft 34, adjacent to the locating portion 32 and located at a side of the slot 340. An end of the protruding portion 36 facing the slot 340 forms a block 348.

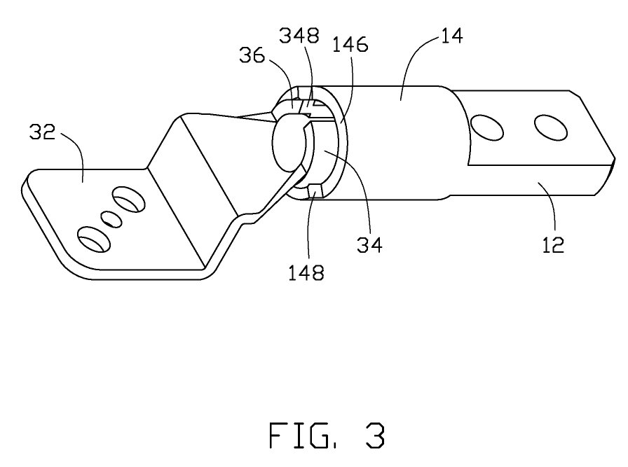

Referring to FIG. 3, in assembly, the shaft 34 is compressed to enter the receiving space 140. After entering the receiving space 140, the shaft 34 is released and restores to elastically resist against the inner wall of the shaft sleeve 14. The projecting part 346 is engaged in the groove 144 for preventing the second element 30 from disengaging from the shaft sleeve 14. Consequently, the locating protrusion 344 and the protruding portion 36 resist against the inner wall of the shaft sleeve 14.

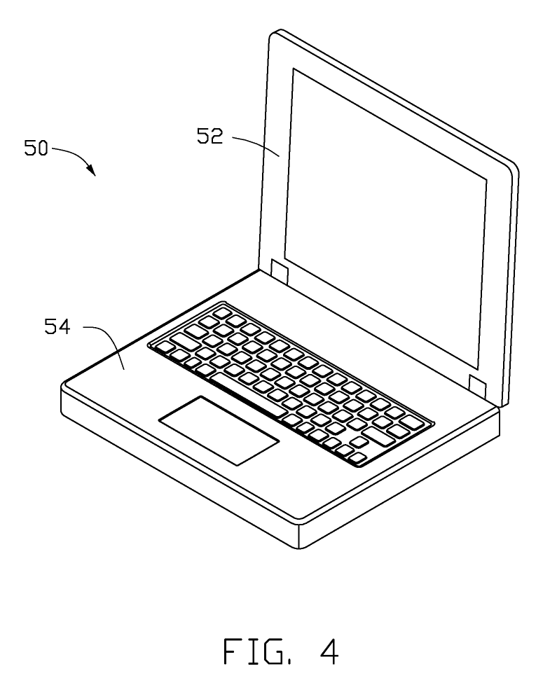

Referring to FIG. 4, the hinge can be utilized in a collapsible device 50, here for instance, in a notebook computer that includes a base 54 and a cover 52. The connecting portion 12 is fixed to one of the cover 52 and the base 54, and the locating portion 32 is fixed to the other one of the cover 52 and the base 54. When the cover 52 is closed the protruding portion 36 resists against the inner wall of the shaft sleeve 14, as a result, the shaft 34 is greatly deformed.

When the cover 52 is rotated away from the base 54, the shaft 34 is rotated in the receiving space 140, until the protruding portion 36 is slid into the depressed part 146 along the inner wall of the shaft sleeve 14. As a result, the shaft 34 is restored, which happens gradually because the protruding portion 36 is arc-shaped, friction between the shaft 34 and the shaft sleeve 14 reduces gradually. Accordingly, the cover 52 is easily rotated relative to the base 54. The shaft 34 cannot be rotated further when the block 348 resists against the stop surface 148. As a result, the cover 52 cannot be over-rotated. In this process, the locating protrusion 344 may be engaged in the locating hole 142, to provide a tactile sensation to users.

When the cover 52 is rotated towards the base 54, the shaft 34 is rotated in the receiving space 140, until the protruding portion 36 is slid into the receiving space 140 along the inner surface of the shaft sleeve 14, and the shaft 34 is deformed. The friction between the shaft 34 and the shaft sleeve 14 resists rotation of the cover 52 preventing the cover 52 bumping against the base 54 with too much force.

It is believed that the present embodiment and its advantages will be understood from the foregoing description, and it will be apparent that various changes may be made thereto without departing from the spirit and scope of the description or sacrificing all of its material advantages, the example hereinbefore described merely being an exemplary embodiment.

What is claimed is:

1. A hinge, comprising:
a first element comprising a shaft sleeve, the shaft sleeve defining a receiving space along an axial direction, the shaft sleeve forming a depressed part at its distal end; and
a second element comprising an elastic shaft elastically and pivotably received in the receiving space, a protruding portion protruding from the shaft being capable of sliding into the depressed part.

2. The hinge of claim 1, wherein the protruding portion is arc-shaped and extends out radially from a circumference of the shaft.

3. The hinge of claim 1, wherein the shaft sleeve defines a groove in the inner wall of the shaft sleeve; the shaft defines a projecting part on the circumference of the shaft, the projecting part is engagable in the groove.

4. The hinge of claim 1, wherein the shaft is tube-shaped, and defines a slot in a circumference of the shaft along an axial direction and extending through opposite ends of the shaft.

5. The hinge of claim 1, wherein the shaft sleeve defines a locating hole in a circumference, a locating protrusion is protruded from a circumference of the shaft, and the locating protrusion is engagable in the locating hole.

6. The hinge of claim 5, wherein the protrusion is protruded from the circumference of the shaft.

7. The hinge of claim 1, wherein the shaft is tube-shaped and defines a slot in a circumference of the shaft along an axial direction and extending through opposite ends of the shaft; the protruding portion is positioned at a side of the slot, with an end of the protruding portion facing the slot.

8. The hinge of claim 1, wherein the shaft is tube-shaped and defines a slot in a circumference of the shaft along an axial direction and extending through opposite ends of the shaft, the protruding portion is positioned at a side of the slot, with an end of the protruding portion facing the slot and forming a block, the depressed part extends along a circumference of the shaft sleeve, and a stop surface facing the depressed part is defined on one end of the depressed part, the block is resisted against the stop surface.

9. A collapsible device comprising:
a base;
a hinge comprising:
a first element comprising a shaft sleeve, the shaft sleeve defining a receiving space along an axial direction, the shaft sleeve forming a depressed part at its distal end; and
a second element comprising an elastic shaft elastically and pivotably received in the receiving space, a protruding portion protruding from the shaft being capable of sliding into the depressed part; and
a cover pivotally mounted to the base via the hinge;
wherein the first element is fixed to one of the base and the cover, and the second element is fixed to the other one of the base and the cover.

10. The collapsible device of claim 9, wherein the protruding portion is arc-shaped and extends out radially from a circumference of the shaft.

11. The collapsible device of claim 9, wherein the shaft sleeve defines a groove in the inner wall of the shaft sleeve; the shaft defines a projecting part on the circumference of the shaft, the projecting part is engagable in the groove.

12. The collapsible device of claim 9, wherein the shaft is tube-shaped, and defines a slot in a circumference of the shaft along an axial direction and extending through opposite ends of the shaft.

13. The collapsible device of claim 9, wherein the shaft sleeve defines a locating hole in a circumference, a locating protrusion is protruded from a circumference of the shaft, the locating protrusion is engagable in the locating hole.

14. The collapsible device of claim 13, wherein the protrusion is protruded from the circumference of the shaft.

15. The collapsible device of claim 9, wherein the shaft is tube-shaped and defines a slot in a circumference of the shaft along an axial direction and extending through opposite ends of the shaft, the protruding portion is positioned at a side of the slot, with an end of the protruding portion facing the slot.

16. The collapsible device of claim 9, wherein the shaft is tube-shaped and defines a slot in a circumference of the shaft along an axial direction and extending through opposite ends of the shaft, the protruding portion is at a side of the slot, with an end of the protruding portion facing the slot and forming a block, the depressed part extends along a circumference of the shaft sleeve, and a stop surface facing the depressed part is defined on one end of the depressed part, the block is resisted against the stop surface.
